(19) United States
(12) Patent Application Publication
(10) Pub. No.: US 2026/0159092 A1
(43) Pub. Date: Jun. 11, 2026

(54) VEHICLE AND METHOD OF CONTROLLING THE SAME

(71) Applicants: HYUNDAI MOTOR COMPANY, Seoul (KR); KIA CORPORATION, Seoul (KR)

(72) Inventors: Guang Li XUE, Shandong (CN); Tian Li HUANG, Shandong (CN); Shi Wen WANG, Shandong (CN)

(73) Assignees: HYUNDAI MOTOR COMPANY, Seoul (KR); KIA CORPORATION, Seoul (KR)

(21) Appl. No.: 18/977,631

(22) Filed: Dec. 11, 2024

(30) Foreign Application Priority Data
Dec. 9, 2024 (CN) 202411796928.5

(51) Int. Cl. B60W 30/182; B60W 50/00; G07C 9/00

(52) U.S. Cl. CPC B60W 30/182; B60W 50/0098; G07C 9/00309; B60W 2556/45; G07C 2009/00793; G07C 2009/00984; G07C 2209/08; G07C 2209/63

(57) ABSTRACT

A vehicle includes at least one processor, and a memory operatively connected to the at least one processor and configured to store one or more programs executed by the at least one processor, wherein the processor includes a first processing unit configured to determine a first position of a fob key at a first time point when a control command of the fob key is received and determine a second position of the fob key after a third time point when a preset time elapses from a second time point when the reception of the control command ends when the first position is in a reference area, and a second processing unit configured to control the vehicle to operate in a welcome mode when the second position is in the reference area.

### CROSS-REFERENCE TO RELATED APPLICATION

The present application claims priority to Chinese Patent Application No. 202411796928.5, filed on Dec. 9, 2024, the entire contents of which is incorporated herein for all purposes by this reference.

### BACKGROUND OF THE PRESENT DISCLOSURE

### Field of the Present Disclosure

The present disclosure relates to a vehicle and a method for controlling the same.

### Description of Related Art

When a driver takes a necessary action while holding a smart key in a vehicle, a smart key system for detecting the driver's action by a system built into the vehicle to control the operation of the vehicle is being applied. Here, the smart key is commonly called a “Fob key” and is also called a fob key for short.

The smart key system includes a remote keyless entry (RKE) system allowing remotely opening and closing a vehicle door in a wireless manner without a key to open or close the vehicle door, and a passive keyless entry (PKE) system allowing a driver or vehicle owner to open (unlock) the vehicle door, close (lock) the door, and start an engine in a wireless manner at a position close to the vehicle.

The smart key system for a vehicle is composed of a plurality of low frequency (LF) antennae for covering a vehicle indoor area and an outdoor area adjacent to the vehicle as a communication available area, a radio frequency (RF) antenna for receiving RF signals from a fob key, and an SMK electronic control unit (ECU).

Meanwhile, smart key systems of recent vehicles provide a driver with a welcome light function and a smart tailgate function. Here, the welcome light function and the smart tailgate function are functions of automatically turning on a light emitting diode (LED) of a door handle and opening a tailgate when the driver with the registered fob key of the vehicle approaches the door or tailgate (trunk) of the vehicle.

The welcome function needs to be provided when the smart key approaches the vehicle. However, when, in the process of determining a position of the smart key, an error occurs or there is a mistake in the system, there may be a problem that the welcome function is operated regardless of the driver's intention.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle and a method for controlling the same, which are configured for preventing a malfunction of a welcome function of the vehicle.

Furthermore, the present disclosure is directed to providing a vehicle and a method for controlling the same, which are configured for preventing the operation of a welcome function in a driver's unintended situation.

According to an exemplary embodiment of the present disclosure, there is provided a vehicle including at least one processor, and a memory operatively connected to the at least one processor and configured to store one or more programs executed by the at least one processor, wherein the at least one processor includes a first processing unit configured to determine a first position of a fob key at a first time point when a control command of the fob key is received and determine a second position of the fob key after a third time point when a preset time elapses from a second time point when the reception of the control command ends when the first position is in a reference area, and a second processing unit configured to control the vehicle to operate in a welcome mode when the second position is in the reference area.

The first processing unit may periodically determine the second position of the fob key using a radio frequency (RF) response signal received after the third time point.

The second processing unit may be configured for controlling the vehicle to operate in the welcome mode when the second position moves from the outside of the reference area to the inside of the reference area.

The first processing unit may be configured to determine a third position of the fob key when the first position is outside the reference area.

The second processing unit may be configured for controlling the vehicle to operate in the welcome mode when the third position is in the reference area.

The first time point may be a time point when the reception of the control command of the fob key starts in a locked state of doors of the vehicle.

The control command may be continuously received for a predetermined time period.

The control command may include a window close command of the vehicle.

The second processing unit may be configured for controlling the vehicle not to operate in the welcome mode when receiving an RF response signal from the fob key within a preset critical time from the second time point.

The vehicle may provide at least one of automatic side mirror control, automatic door handle lighting control, automatic welcome light control, automatic indoor lighting control, automatic vehicle seat position control, automatic mirror position control, and automatic air conditioning function control functions in the welcome mode.

The first processing unit may be configured to determine the position of the fob key using a signal strength of a response signal received from the fob key.

According to an exemplary embodiment of the present disclosure, there is provided a method performed by a computing device including at least one processor and a memory operatively connected to the at least one processor and configured to store one or more programs executed by the at least one processor, the method including, by the at least one processor, determining a first position of a fob key at a first time point when a control command of the fob key is received, determining a second position of the fob key after a third time point when a preset time elapses from a second time point when the reception of the control command ends when the first position is in a reference area, and controlling a vehicle to operate in a welcome mode when the second position is in the reference area.

The determining of the second position of the fob key may include periodically determining the second position of the fob key using a radio frequency (RF) response signal after the third time point.

The controlling of the vehicle to operate in the welcome mode may include determining whether the second position is outside the reference area, determining whether the second position has entered from the outside of the reference area to the inside of the reference area, and controlling the vehicle to operate in the welcome mode.

The method may further include, after the determining of the first position, periodically determining a third position of the fob key from the second time point when the first position is outside the reference area.

The controlling of the vehicle to operate in the welcome mode may further include controlling the vehicle to operate in the welcome mode when the third position is in the reference area.

The first time point may be a time point when the reception of the control command of the fob key starts in a locked state of doors of the vehicle.

The method may further include controlling the vehicle not to operate in the welcome mode when receiving an RF response signal from the fob key within a preset critical time from the second time point.

The controlling of the vehicle to operate in the welcome mode may include controlling the vehicle to provide at least one of automatic side mirror control, automatic door handle lighting control, automatic welcome light control, automatic indoor lighting control, automatic vehicle seat position control, automatic mirror position control, and automatic air conditioning function control functions.

The method may further include, between the determining of the first position and the determining of the second position, continuously receiving the control command through a communication device.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view for describing a vehicle according to an exemplary embodiment of the present disclosure;

FIG. 2 is a block diagram illustrating a configuration of the vehicle according to the embodiment;

FIG. 3 is a block diagram illustrating a configuration of a user terminal according to the embodiment;

FIG. 4 is a block diagram illustrating a configuration of a fob key according to the embodiment;

FIG. 5 is a view for describing the operation of the vehicle according to the embodiment;

FIG. 6 and FIG. 7 are views for describing the operation of a processor according to the embodiment; and

FIG. 8 and FIG. 9 are flowcharts of vehicle control methods according to various exemplary embodiments of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings.

However, the technical spirit of the present disclosure is not limited to some of the described embodiments, but may be implemented in various different forms, and at least one of the components among the exemplary embodiments of the present disclosure may be used by being selectively coupled or substituted without departing from the scope of the technical spirit of the present disclosure.

Furthermore, terms (including technical and scientific terms) used in embodiments of the present disclosure may be construed as meaning which may be generally understood by those skilled in the art to which an exemplary embodiment of the present disclosure pertains unless explicitly specifically defined and described, and the meanings of the commonly used terms, such as terms defined in a dictionary, may be construed based on contextual meanings of related technologies.

Furthermore, the terms used in the exemplary embodiments of the present disclosure are for describing the exemplary embodiments and are not intended to limit the present disclosure.

In the specification, a singular form may include a plural form unless otherwise specified in the phrase, and when described as “at least one (or one or more) of A, B, and C,” one or more among all possible combinations of A, B, and C may be included.

Furthermore, terms such as first, second, A, B, (a), and (b) may be used to describe components of the exemplary embodiments of the present disclosure.

These terms are only for distinguishing one component from another component, and the nature, sequence, order, or the like of the corresponding components is not limited by these terms.

Furthermore, when a first component is described as being “connected,” “coupled,” or “joined” to a second component, it may include a case in which the first component is directly connected, coupled, or joined to the second component, but also a case in which the first component is “connected,” “coupled,” or “joined” to the second component by other components present between the first component and the second component.

Furthermore, when the first component is described as being formed or disposed on “on (above) or below (under)” the second component, “on (above)” or “below (under)” may include not only a case in which two components are in direct contact with each other, but also a case in which one or more third components are formed or disposed between the two components. Furthermore, when described as “on (above) or below (under),” it may include the meaning of not only an upward direction but also a downward direction based on one component.

Hereinafter, various exemplary embodiments will be described in detail with reference to the accompanying drawings, and the same or corresponding components are denoted by the same reference numeral regardless of the reference numerals, and overlapping descriptions thereof will be omitted.

For purposes of the present application and the claims, using the exemplary phrase “at least one of: A; B; or C” or “at least one of A, B, or C,” the phrase means “at least one A, or at least one B, or at least one C, or any combination of at least one A, at least one B, and at least one C. Furthermore, exemplary phrases, such as “A, B, and C”, “A, B, or C”, “at least one of A, B, and C”, “at least one of A, B, or C”, etc. As used herein may mean each listed item or all possible combinations of the listed items. For example, “at least one of A or B” may refer to (1) at least one A; (2) at least one B; or (3) at least one A and at least one B.

Throughout the present disclosure, references to components, units, or modules generally refer to items that logically may be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

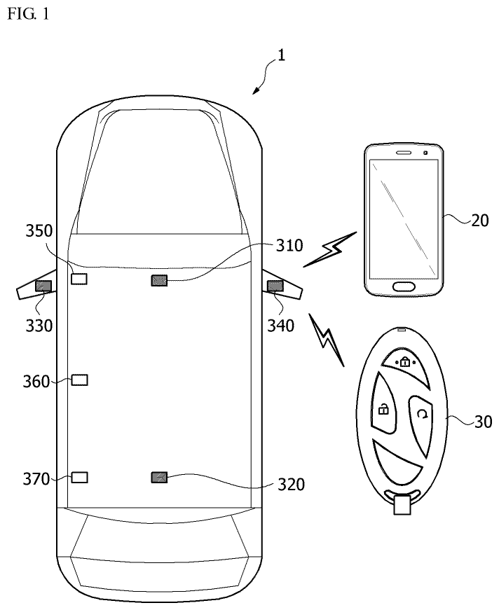

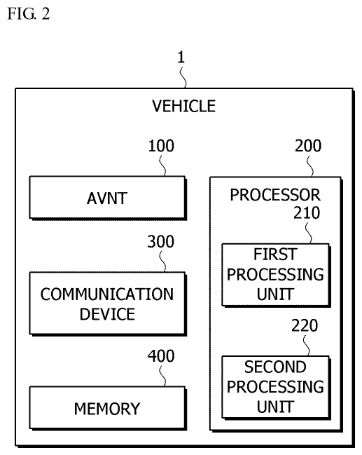

FIG. 1 is a view for describing a vehicle according to an exemplary embodiment of the present disclosure, and FIG. 2 is a block diagram illustrating a configuration of the vehicle according to the exemplary embodiment of the present disclosure. Referring to FIG. 1 and FIG. 2, a vehicle 1 according to the exemplary embodiment of the present disclosure may include an audio video navigation and telematics (AVNT) 100, a processor 200, a communication device 300, and a memory 400.

The vehicle 1 may include the AVNT 100 provided in a center fascia and controlling an audio device, an air conditioner, a Bluetooth device, a seat heater, and the like.

An input device for receiving a user input may be disposed in the center fascia or the AVNT 100, and a display device for displaying operation information for at least one of functions performed in the vehicle 1 may also be disposed.

The input device may include hardware devices such as various buttons or switches, pedals, a keyboard, a mouse, a track-ball, various levers, a handle, or a stick.

Furthermore, the input device may include a graphical user interface (GUI), that is, a software device, such as a touch pad. The touch pad may be implemented as a touch screen panel (TSP) to form a mutual layer structure with a display panel of the display device.

The display device may function as a user interface. The display device may display the vehicle's operating state, control state, route/traffic information, energy remaining information, content requested by a driver, and the like by a processor.

Furthermore, the display device may be configured as a touch screen configured for detecting a driver input to receive the driver's request that instructs the processor.

The interior of a vehicle body may include a keyway into which a fob type or card type remote controller may be inserted. Here, the keyway may be provided on a dashboard or center fascia and provided at a position adjacent to a driver's seat.

The vehicle 1 may transmit and receive information with a remote controller or a terminal when the remote controller is inserted into the keyway or when authentication with the remote controller or terminal is completed via a wireless communication network.

The interior of the vehicle body may further include a start button that receives ON/OFF commands. Therefore, the vehicle starts when the start button is pressed by the user after the authentication with the remote controller or terminal is completed.

The vehicle 1 may further include a communication device for transmitting and receiving information with at least one of electronic devices and a terminal 20 that are provided in the vehicle.

The communication device 300 may include one or more components that enable communication between in-vehicle components and for example, may include at least one of a short-range communication module, a wired communication module, and a wireless communication module.

Furthermore, the communication device 300 may include at least one of a wired communication module and a wireless communication module for communicating with a user terminal 20 and a server 30.

For example, the short-range communication module may include various short-range communication modules for transmitting and receiving signals using a wireless communication network at a short distance, such as a Bluetooth module, an infrared communication module, a radio frequency (RF) identification communication module, a wireless local access network (WLAN) communication module, a near-field communication (NFC) communication module, or a Zigbee communication module.

For example, the wired communication module may include not only various wired communication modules such as a Controller Area Network (CAN) communication module, a Local Area Network (LAN) module, a wide area network (WAN) module, and a value added network (VAN) module, but also various cable communication modules such as a universal serial bus (USB), a high definition multimedia interface (HDMI), a digital visual interface (DVI), a recommended standard 232 (RS-232), power line communication, and plain old telephone service (POTS).

For example, a Controller Area Network (CAN) may include a communication protocol designed for real-time data exchange between microcontrollers and devices within vehicles and industrial systems. CAN may allow multiple electronic control units to communicate with each other without the need for a host computer, making it useful for applications where reliable, high-speed communication is critical.

For example, a value added network (VAN) may include a private network which may provide businesses with secure, reliable communication channels for exchanging data and documents. VANs may offer services (e.g., data encryption, format translation, message routing, or tracking, etc.) to ensure that business documents (e.g., invoices, purchase orders, or shipping notices, etc.) may be transmitted efficiently and/or securely between trading partners.

The wired communication module may further include a Local Interconnect Network (LIN). For example, a Local Interconnect Network (LIN) may include a low-cost serial communication protocol which may be used in automotive systems to connect electronic components (e.g., sensors, actuators, or control units, etc.). For example, for simplicity and/or cost-efficiency, LIN may manage functions that do not require high-speed data transfer (e.g., window controls, seat adjustments, lighting, or climate control, etc.). LIN may function on a single-master, multiple-slave architecture, where one master node may coordinate communication with multiple slave nodes.

Furthermore, in addition to the Wi-Fi module and the Wireless Broadband (WiBro) module, the wireless communication module may include a wireless communication module for supporting various wireless communication methods, such as Global System for Mobile communication (GSM), Code Division Multiple Access (CDMA), Wideband Code Division Multiple Access (WCDMA), Universal Mobile Telecommunications System (UMTS), Time Division Multiple Access (TDMA), and Long Term Evolution (LTE).

The user terminal 20 communicate with the vehicle 1, receives at least one of a vehicle door lock and unlock command, a tailgate lock and unlock command, a start command, a lamp lighting command, and a start command as a user input, and transmits information corresponding to the received command to the vehicle. The user terminal 20 may transmit the information corresponding to the received command to the vehicle as a communication signal.

The user terminal 20 may be implemented as a computer or portable terminal which may be communicatively connected to the vehicle via a network.

Here, the computer may include, for example, a notebook, desktop, laptop, tablet PC, slate PC, or the like which is provided with a WEB browser, and the portable terminal is a wireless communication device that ensures portability and mobility and may include, for example, any kind of handheld-based wireless communication device such as a personal communication system (PCS), a GSM, a personal digital cellular (PDC), a personal handyphone system (PHS), a personal digital assistant (PDA), an international mobile telecommunication (IMT)-2000, CDMA-2000, WCDMA, and wireless broadband Internet (WiBro) terminals, and a smartphone, and wearable devices such as a watch, a ring, a bracelet, an anklet, a necklace, glasses, contact lenses, or a head-mounted-device (HMD).

In an exemplary embodiment of the present disclosure, the user terminal 20 may communicate with the vehicle through a Bluetooth low energy (BLE) communication method. The user terminal 20 may perform communication based on the Bluetooth beacon standard (iBeacon).

The AVNT 100 is the term referring to an in-vehicle information and entertainment system and may be a system that integrates navigation, audio, video, and communication functions. The AVNT 100 may output a message generated by the processor 200 in at least one of a visual manner, an audible manner, or a combination thereof.

The AVNT 100, the processor 200, and the communication device 300 may be implemented as one module, but in the exemplary embodiment of the present disclosure, will be described separately for convenience of description.

The AVNT 100 may be a component for providing a hardware interface integrated into the system in the vehicle. The AVNT 100 may perform system control for a screen, buttons, and various integrated information and entertainment functions.

The AVNT 100 may be provided at the center or console of the vehicle dashboard to provide vehicle information and an entertainment interface. The information and entertainment system may include AM/FM radio, satellite radio, DVDs/CDs, cassette tapes, USB MP3, dashcams, Global Positioning System (GPS) navigation devices, Bluetooth, Wi-Fi, and the like and also provide the state information of the vehicle system. Furthermore, the AVNT 100 may perform functions such as voice control and motion recognition.

The processor 200 may be configured for controlling the vehicle body such as a vehicle, doors, windows, or keys (a digital key, a smartphone key, and a fob). The processor is configured to perform a body control function (BCM), a smart key entry/start function (SMK), a tire air pressure monitoring function (TPMS), an immobilizer function (IMMO), digital key authentication (IAU), an autonomous parking related control function (PDW), and the like. For example, the processor 200 may be a body domain controller (BDC), but is not limited thereto, and may be used to encompass a platform controller configured for providing electronic convenience functions to a body domain area.

The communication device 300 may perform pairing between the user terminal 20 and the vehicle 1 using a Bluetooth signal.

The communication device 300 may include a transceiver for transmitting and receiving information using an antenna, a communication circuit, a communication processor, and the like and perform short-range communication with the user terminal 20. According to an exemplary embodiment of the present disclosure, the communication device 300 may perform Bluetooth communication, NFC communication, or UWB communication. The communication device 300 may be provided adjacent to a door handle of the vehicle 1 to request authentication information when it is determined that the user terminal approaches within a predetermined distance.

In the Bluetooth standard, Bluetooth 1.0 stipulates that a data transmission rate is 1 Mbps and a transmission distance ranges from 10 to 100 m, and communication is possible even in the presence of obstacles because Bluetooth 1.0 utilizes a high radio frequency of 2.4 GHZ.

The communication device 300 according to the exemplary embodiment of the present disclosure may measure the position of the user terminal under the control of the processor 200 when the user terminal including a fob key or a digital key approaches the outside of the vehicle 1, unlock the vehicle door according to the result of positioning, and control the remote start of the vehicle 1 to be performed.

The communication device 300 may include a plurality of positioning modules 310, 320, 330 and 340. The positioning modules 310, 320, 330 and 340 may be short-range wireless communication modules, and each wireless communication module may measure the strength of a wireless signal received from the user terminal 20. One of the plurality of wireless communication modules mounted on the vehicle 1 may be set as a master module. The master module may collect the strength of a wireless signal measured by another wireless communication module and transmit the strength to the processor.

For example, the positioning modules 310, 320, 330 and 340 may include a Bluetooth module, a low-power Bluetooth module, a Wi-Fi module, and the like. The positioning modules 310, 320, 330 and 340 may include an FRT(Front) antenna provided at the front of the vehicle and mounted on the AVNT, an RR(Rear) antenna provided at the rear of the vehicle and mounted on a shark antenna, an LH(Left Hand) antenna mounted on a left O/S(Off-Side) mirror, and an RH(Right Hand) antenna mounted on a right O/S mirror. A wireless signal strength of the user terminal 20 may be independently measured and transmitted to a master module.

Furthermore, the communication device may include a plurality of Low Frequency (LF) antennae 350, 360 and 370. The LF antennae 350, 360 and 370 are each disposed inside in-vehicle areas frequently accessed by a user, such as a driver's seat, a passenger door, and a trunk, and emit low-frequency signals to detect the fob key. The LF signals may communicate with the fob key in the range of about 1 to 2 meters to detect the fob key positioned within the above range. The LF antenna may detect the fob key using a low frequency band of 125 kHz or 134.2 kHz.

The fob key receiving the low frequency signals of the LF antennae 350, 360 and 370 may transmit Radio Frequency (RF) signals to the processor in response to the low frequency signals.

The processor 200 may perform the overall control of the vehicle 1. The processor 200 may be configured to execute applications and instructions that are stored in the memory 400.

In an exemplary embodiment of the present disclosure, the processor 200 may include a first processing unit 210 and a second processing unit 220.

The processor 200 may be a main CPU for overall control of the vehicle 1. In an exemplary embodiment of the present disclosure, the processor 200 may perform a pairing operation by executing a Bluetooth application to perform communication between the Bluetooth application and the communication device.

The processor 200 may be configured to determine a relative position of the user terminal 20 with respect to the vehicle 1. In an exemplary embodiment of the present disclosure, the relative position may include a distance between the vehicle 1 and the user terminal 20 and a direction in which the user terminal 20 or the fob key 30 is positioned with respect to the vehicle 1.

For example, the processor 200 may be configured to determine the relative position using at least one of the Wi-Fi, Bluetooth, and low-power Bluetooth methods.

The processor 200 may compare the positioning result with the positioning pattern and determine the relative position of the user terminal 20.

For example, the processor 200 may be configured to determine the relative position between the vehicle and the user terminal using a received signal strength indicator (RSSI) method which is configured for measuring the strength of a Wi-Fi signal to estimate a distance.

Alternatively, the processor 200 may be configured to determine the relative position between the vehicle and the user terminal using the RSSI method which is configured for measuring the strength of a Bluetooth signal to estimates a distance.

Alternatively, the processor 200 may measure the strength of the RF signal to determine the relative position between the vehicle and the fob key in a triangulation method.

The memory 400 may store an application and various pieces of data for controlling the vehicle 1 and load the application or read or write the data at the request of the processor 200.

The memory 400 may store at least one algorithm that performs determination or execution of various commands for operating the processor 200 according to the exemplary embodiment of the present disclosure. The memory 400 may include at least one storage medium of a flash memory, a hard disc, a memory card, a read-only memory (ROM), a random access memory (RAM), an electrically erasable programmable ROM (EEPROM), a programmable ROM (PROM), a magnetic memory, a magnetic disc, and an optical disc.

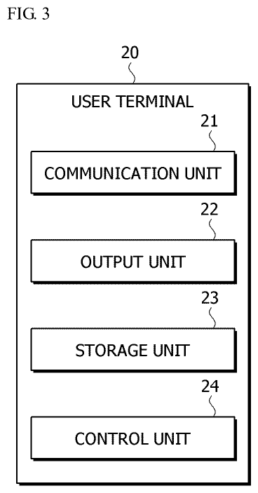

FIG. 3 is a block diagram illustrating a configuration of the user terminal according to the exemplary embodiment of the present disclosure.

Referring to FIG. 3, the user terminal 20 may include a communication unit 21, an output unit 22, a storage unit 23, and a control unit 24.

The user terminal 20 may include a smartphone, a smart pad, a notebook computer, and the like that the user can carry. The user terminal 20 may store a digital key that generates authentication information for controlling functions such as locking and unlocking of the vehicle door, remote starting, emergency alarm, and trunk opening.

The communication unit 21 may include a transceiver for transmitting and receiving information using an antenna, a communication circuit, a communication processor, and the like and perform short-range communication with the vehicle.

According to an exemplary embodiment of the present disclosure, the communication unit 21 may perform NFC communication or UWB communication.

The output unit 22 may output information stored in the user terminal 20 in at least one of a visual manner, an audible manner, or a combination thereof. According to an exemplary embodiment of the present disclosure, the output unit 22 may be implemented as a display device that adopts a liquid crystal display (LCD) panel, a light emitting diode (LED) panel, an organic light emitting diode (OLED) panel, a plasma display panel (PDP), or the like. The LCD may include a thin film transistor LCD (TFT-LCD). The output unit 22 may be implemented by being formed integrally with the input unit by a touch screen panel (TSP).

The storage unit 23 may store at least one algorithm that performs determination or execution of various commands for operating the user terminal 20 according to various exemplary embodiments of the present disclosure. The storage unit 23 may include at least one storage medium of a flash memory, a hard disc, a memory card, a ROM, a RAM, an EEPROM, a PROM, a magnetic memory, a magnetic disc, and an optical disc. The storage unit 23 may store driver information for a plurality of vehicles.

The control unit 24 may be implemented by various processing devices such as a microprocessor including a semiconductor chip configured for performing determinations or executions of various commands embedded therein and may be configured for controlling the operation of the user terminal 20 according to the exemplary embodiment of the present disclosure. The control unit 24 may be electrically connected to the communication unit 21, the output unit 22, and the storage unit 23 through a wired cable or various circuits to transmit electrical signals including control commands and the like and may transmit and receive electrical signals including control commands and the like by various wireless communication networks such as a CAN.

In an exemplary embodiment of the present disclosure, the user terminal 20 may operate as a digital key. Hereinafter, the digital key and the user terminal may be used as terms referring to the same component.

The digital key 20 may open or close the door provided in the vehicle 1, start or stop the vehicle 1, and execute various functions included in the vehicle 1 as needed. The digital key 20 may be a device which may use one or more of low-power Bluetooth (BLE) communication and NFC.

One digital key 20 may be operated by being linked to a specific vehicle 1, and as needed, a plurality of digital keys 20 may be linked to one vehicle 1 or one digital key 20 may be linked to a plurality of vehicles 1. Furthermore, there may be a case in which a plurality of digital keys 20 are linked to a plurality of vehicles 1.

Furthermore, the digital key 20 may be provided and operated in a device such as a smartphone, and there may be a case in which a plurality of digital keys 20 are provided in one smartphone. Although the exemplary embodiment describes an example in which the digital key 20 is provided and operated in the smartphone, the present disclosure is not limited thereto, and as needed, the digital key 20 may be provided in a device other than the smartphone.

The digital key 20 may be configured for controlling the vehicle 1 and to the present end, may communicate with the vehicle 1 through low-power Bluetooth communication, UWB communication, wireless Internet network communication, or mobile communication network communication.

The digital key 20 may be manipulated by the user to perform various functions controlling the vehicle 1 and manipulated to set one or more wireless anchors.

The digital key 20 may search for nearby wireless anchors and register the searched wireless anchors. That is, the digital key 20 may use various communication methods to search for wireless anchors which may be communicatively connected in a wireless communication manner. For example, when two wireless anchors are positioned adjacent to the digital key 20 and one wireless anchor may perform communication through low-power Bluetooth communication and the other may perform communication through wireless Internet network communication, the digital key 20 may be communicatively connected to one of the two wireless anchors or communicatively connected to both wireless anchors.

In an exemplary embodiment of the present disclosure, the wireless anchor may be the same component as the positioning module.

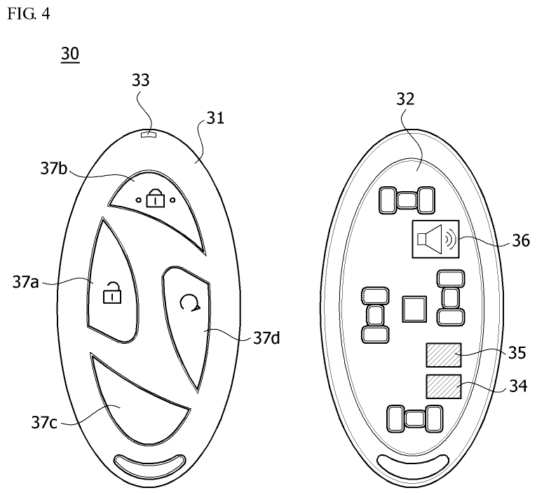

FIG. 4 is a block diagram illustrating a configuration of the fob key according to the exemplary embodiment of the present disclosure. Referring to FIG. 4, the fob key 30 may include a housing 31 made of a plastic material, and a printed circuit board (PCB) 32 may be disposed inside the housing. Various buttons for controlling vehicle doors may be disposed on the exterior of the housing 31. For example, a vehicle door open button 37a, a vehicle door lock button 37b, a trunk open button 37c, and a hold button 37d may be disposed on the exterior of the housing 31. Each button may be electrically connected to the PCB 32 inside the housing.

Furthermore, a light source 33 for outputting a visual signal may be provided on the exterior of the housing 31. The light source 33 may be electrically connected to the PCB 32 inside the housing 31. A housing area surrounding the light source 33 may be made of a transparent material so that an optical signal output from the light source 33 may be identified from the outside thereof.

The PCB 32 may include a signal processing module 34 for converting a signal input from a button into an electrical signal and a communication module 35 for transmitting the converted electrical signal to the vehicle. The communication module 35 may include an LF module and an RF module.

Furthermore, a speaker 36 for outputting an auditory signal may be built in the housing 31 and electrically connected to the PCB 32.

The light source 33 and the speaker 36 may be operated under the control of the signal processing module 34.

In an exemplary embodiment of the present disclosure, the fob key 30 may operate as a smart key. The processor 200 may transmit a plurality of LF signals using a plurality of electrically connected LF antennae. For example, the processor 200 may transmit the plurality of LF signals through the plurality of LF antennae every specified cycle to detect the fob key 30.

In an exemplary embodiment of the present disclosure, the LF signal utilizes a frequency of 125 kHz, and a radio transmission range may be within about 5 m.

In an exemplary embodiment of the present disclosure, the RF signal utilizes a frequency of 315 MHz or 433 MHz, and a radio transmission range may be within about 30 m.

Therefore, since the LF signal reaches only at a short distance, the LF signal may be used to detect whether the fob key 30 is in a specific area of the vehicle 1.

When the fob key 30 receives the LF signal of the vehicle 1, the fob key 30 may transmit the RF signal in response to the LF signal. The RF signal may include a unique ID of the fob key 30 and other authentication information. The fob key 30 may include information measuring the strength of the received LF signal in the RF signal.

The vehicle 1 may receive the RF signal of the fob key 30 through RF receiving antennae provided at a plurality of positions. The processor 200 may analyze the strength of the received RF signal (RSSI) to determine the position of the fob key 30. For example, the processor 200 may compare the strengths of the RF signals received from the plurality of RF receiving antennae and triangulate the position of the fob key 30. The processor 200 may be configured to determine the position of the fob key 30 in combination of the strength of the RF signal and the range of the LF signal. For example, when a strong LF signal is received adjacent to a specific door handle, the processor 200 may be configured to determine that the fob key 30 is adjacent to the corresponding door.

The vehicle 1 may perform any operation in accordance with the position of the fob key 30. For example, when the fob key 30 is adjacent to a driver's seat door, the door may be unlocked, and when the fob key 30 is adjacent to the trunk, the trunk may be opened. Inside the vehicle, an engine start button may be activated by checking whether the fob key 30 is in the driver's seat.

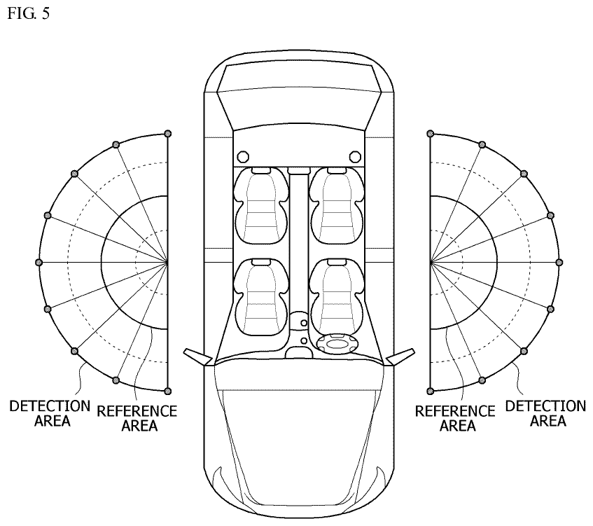

FIG. 5 is a view for describing the operation of the vehicle according to the exemplary embodiment of the present disclosure. Referring to FIG. 5 together, the vehicle 1 may transmit the LF signal to the fob key 30 approaching a detection area, receive an RF response signal in response to the LF signal, and determine the position of the fob key 30. When the fob key 30 enters the welcome area, the vehicle 1 may operate in a welcome mode to provide various functions.

For example, the vehicle 1 may provide at least one of automatic side mirror control, automatic door handle lighting control, automatic welcome light control, automatic indoor lighting control, automatic vehicle seat position control, automatic mirror position control, and automatic air conditioning function control functions in the welcome mode.

Automatic side mirror control function is that automatically adjusts the side mirrors based on driving conditions or user settings, such as folding them when the vehicle is locked or repositioning them during parking.

Automatic door handle lighting control function is that activates door handle lights automatically in low-light conditions or when the vehicle is unlocked, enhancing visibility and convenience.

Automatic welcome light control function is that turns on exterior or interior lights as the driver approaches the vehicle, providing a welcoming experience and improving safety in dark environments.

Automatic indoor lighting control function is that adjusts interior lighting automatically based on conditions like door opening, ambient light levels, or user preferences.

Automatic vehicle seat position control function is that adjusts the seat position automatically according to stored user profiles or entry/exit scenarios, ensuring comfort and convenience.

Automatic mirror position control function is that automatically adjusts the side or rear-view mirror positions based on preset user profiles or specific driving situations, such as reversing.

Automatic air conditioning function control function is that regulates the air conditioning system automatically by maintaining a preset temperature and adjusting airflow or fan speed based on interior and exterior conditions.

In an exemplary embodiment of the present disclosure, the welcome function may be any function that recognizes the position of the fob key 30 approaching the vehicle 1 to increase driver convenience and enable the driver to more smoothly approach the vehicle 1.

For example, the vehicle 1 may be configured for controlling side mirrors to automatically unfold when the fob key 30 approaches the vehicle 1. Furthermore, a convenient function may be provided so that the light adjacent to the door handle may be turned on to allow the driver to easily approach the vehicle 1 even in a dark environment. Furthermore, headlights and taillights may be automatically turned on. Furthermore, the light inside the vehicle 1 may be automatically turned on.

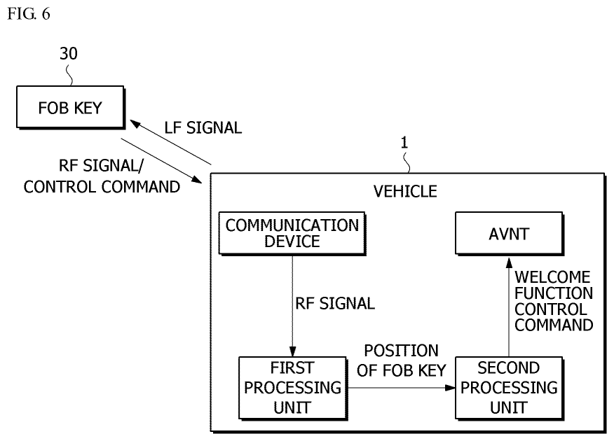

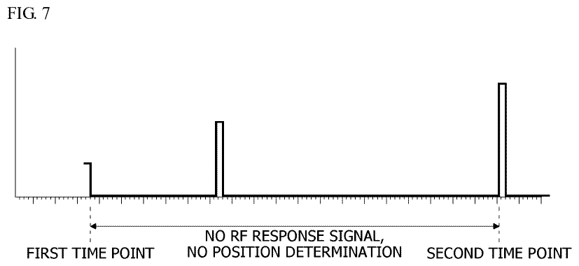

FIG. 6 and FIG. 7 are views for describing the operation of the processor according to the exemplary embodiment of the present disclosure. Referring to FIG. 6 together, the first processing unit 210 may be configured to determine a first position of the fob key 30 at a first time point when receiving a control command of the fob key 30. In an exemplary embodiment of the present disclosure, the control command may include various commands output from the fob key 30. For example, the control command may include a door open command, a door close command, a trunk open command, a window close command, and the like. Furthermore, the control command may be a command which is continuously received for a predetermined time period. For example, the control command may be a command transmitted to the vehicle for a predetermined time period through an operation of pressing the button of the fob key 30 for a predetermined time period, such as a window close command. In the following embodiment, a case in which the control command is a window close command of the vehicle will be referred to as an example.

The door open command is a command that activates the mechanism to unlock and open the vehicle's door, either manually or through remote or automated control.

The door close command is a command that engages the mechanism to securely close the vehicle's door, either manually or through automated assistance.

The trunk open command is a command that triggers the release and opening of the vehicle's trunk for easy access, either manually or via remote or automated control.

The window close command is a command that activates the mechanism to close the vehicle's window, ensuring security and weather protection, either manually or through automated control.

The first time point may be a time point when the window close command of the vehicle is first received through the communication device.

When receiving the window close command of the vehicle, the first processing unit 210 may be configured to determine the first position of the fob key 30 using the RF signal received from the fob key 30 at a first reception time point or a time point closest to the first reception time point.

When the first position is in a reference area, the first processing unit 210 may be configured to determine a second position of the fob key 30 after a third time point when a preset time elapses from the second time point when the reception of the control command ends. In an exemplary embodiment of the present disclosure, the reference area may be a determination range in which the welcome function of the vehicle is provided and set to a radius of about 2 m from the center of the vehicle.

The second time point may be a time point when the reception of the vehicle window close command ends.

Referring to FIG. 7 together, when closing the vehicle window using the fob key 30, the driver needs to hold the pushed door close button of the fob key 30 for a predetermined time period. For example, when the driver wants to completely close the window while the vehicle window is fully open, the driver needs to push the door close button of the fob key 30 for about 9 seconds or more.

In the present way, the control command of the fob key 30 is transmitted to the vehicle communication device as an RF signal between the first time point and the second time point when the door close button of the fob key 30 is pressed. Furthermore, while the control command is output from the fob key 30, the RF response signal to the LF signal of the LF antenna cannot be output. Therefore, it is impossible to determine the relative position of the fob key 30 using the RF response signal to the LF signal between the first time point and the second time point.

Therefore, the first processing unit 210 may be configured to determine that a time point when the same control command output from the fob key 30 ends, that is, a time point at which the reception of the window close command ends, is the second time point.

The first processing unit 210 may receive the RF response signal of the fob key 30 after the second time point when the reception of the control command of the fob key 30 ends and determine the position of the fob key 30.

In an exemplary embodiment of the present disclosure, when the first position is in the reference area, the first processing unit 210 may be configured to determine the second position of the fob key 30 after the third time point when the preset time elapses from the second time point when the reception of the control command ends. That is, when the position of the fob key 30 determined at the time point when the control command of the fob key 30 is first received is in the reference area, the first processing unit 210 may receive the RF response signal at a predetermined time interval from the third time point when a preset time elapses after the time point when the reception of the control command ends and periodically determine the position of the fob key 30. In an exemplary embodiment of the present disclosure, the third time point may be a critical time when the welcome function may be re-provided to the driver in consideration of the time it takes for the fob key 30 to return to the welcome area after leaving the welcome area. For example, the third time point may be a time point after several seconds or tens of seconds elapse from the second time point.

Alternatively, the first processing unit 210 may be configured to determine a third position of the fob key 30 at the second time point when the reception of the control command ends when the first position is outside the reference area. When the position of the fob key 30 determined at the time point when the control command of the fob key 30 is first received is outside the reference area, the first processing unit 210 may receive the RF response signal at a predetermined time interval from the time point when the reception of the control command ends and periodically determine the position of the fob key 30. That is, when the fob key 30 is positioned outside the reference area in which the welcome function may be provided at the time point when the control command of the fob key 30 is first received, the first processing unit 210 may be configured to determine the position of the fob key 30 from the time point when the control command ends to determine whether the welcome function is provided.

The second processing unit 220 may be configured for controlling the vehicle to operate in the welcome mode when the second position is in the reference area. The second processing unit 220 may be configured for controlling the vehicle to provide the welcome function when it is determined that the fob key 30 is positioned in the reference area after the third time point when the preset time elapses after the reception of the control command ends. That is, a driver who controls the vehicle using the fob key 30 in the welcome area waits for a predetermined time period for which the driver may leave the welcome area after completing the control operation, and then determine whether to return to the operation in the welcome mode, preventing the unintended operation of the welcome function.

Alternatively, the second processing unit 220 may be configured for controlling the vehicle to operate in the welcome mode when the second position moves from the outside of the reference area to the inside of the reference area. As described above, the first processing unit 210 may periodically determine the position of the fob key 30 after the third time point and transmit the result of position determination to the second processing unit 220. The second processing unit 220 may be configured for controlling the vehicle to provide the welcome function when the position of the fob key 30 re-enters the reference area after leaving the reference area after the third time point. That is, it is possible to prevent the unintended operation of the welcome function by operating the welcome function only when the driver completes the control operation using the fob key 30, leaves the welcome area, and then re-enters the welcome area.

Alternatively, the second processing unit 220 may be configured for controlling the vehicle not to operate in the welcome mode when receiving the RF response signal from the fob key 30 within a preset critical time from the second time point. In an exemplary embodiment of the present disclosure, the critical time may be set to be the same as the preset time at which the third time point is determined, but is not necessarily limited thereto, and may be set in various ways depending on the vehicle's operating environment and the driver's personal preference. That is, the second processing unit 220 may be configured for controlling the vehicle not to operate in the welcome mode when receiving the RF response signal to the LF signal within a predetermined time period from the time point when the reception of the control command from the fob key 30 ends. In the instant case, the welcome function provided when there is an intention to board the vehicle is controlled not to operate when it is determined that the vehicle driver controls the vehicle through the fob key 30 in the reference area.

Alternatively, the second processing unit 220 may be configured for controlling the vehicle to operate in the welcome mode when the third position is in the reference area. When the position of the fob key 30 determined at the time point when the control command of the fob key 30 is first received is outside the reference area, the second processing unit 220 is configured to control the vehicle so that the welcome function may be provided immediately when the fob key 30 is in the welcome area from the time point when the reception of the control command ends.

Therefore, the vehicle according to the exemplary embodiment can prevent the unintended welcome function from being re-provided to the driver who waits in the vehicle control process using the fob key 30 and prevent discomfort caused by the unintended operation of the welcome function.

For convenience, one or more figures are described by way of an example in which the steps are performed by a processor circuit. One, some, or all steps of the example method of a figure, or portions thereof, may be performed by one or more other circuits. One or some, steps of the example method of a figure may be omitted, performed in other orders, and/or otherwise modified, and/or one or more additional steps may be added.

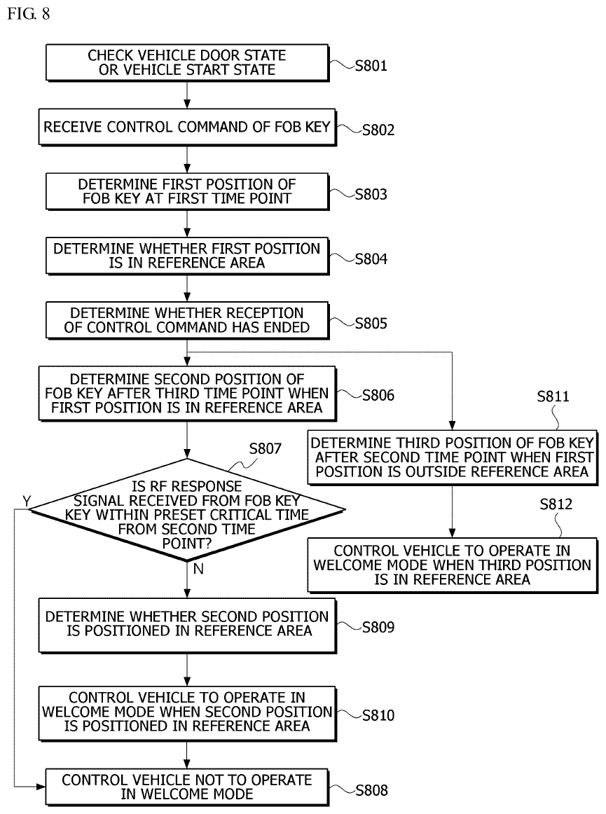

FIG. 8 is a flowchart of a method for controlling the vehicle according to an exemplary embodiment of the present disclosure.

First, a processor is configured to check a closed state of a vehicle door or a turned-off state of the vehicle (S801).

Next, a communication device of the vehicle receives a control command of a fob key (S802).

Next, the processor is configured to determine a first position of the fob key at a first time point when the control command of the fob key is first received (S803).

Next, the processor is configured to determine whether the first position is in a reference area (S804).

Next, the processor is configured to determine whether the reception of the control command has ended (S805).

In a case in which the first position of the fob key is in the reference area, the processor periodically determines a second position of the fob key from a third time point when a preset time elapses from the second time point when the reception of the control command ends (S806).

At the present time, the processor is configured to determine whether an RF response signal has been received from the fob key within a preset critical time from the second time point (S807).

When receiving the RF response signal from the fob key within the preset critical time from the second time point, the processor is configured to control the vehicle not to operate in a welcome mode (S808).

Next, the processor is configured to determine whether the second position is positioned in the reference area (S809).

When the second position is positioned in the reference area, the processor is configured to control the vehicle to operate in the welcome mode (S810).

Alternatively, in a case in which the first position of the fob key is outside the reference area, the processor periodically determines a third position of the fob key from the second time point when the reception of the control command ends (S811).

Next, when the third position is positioned in the reference area, the processor is configured to control the vehicle to operate in the welcome mode (S812).

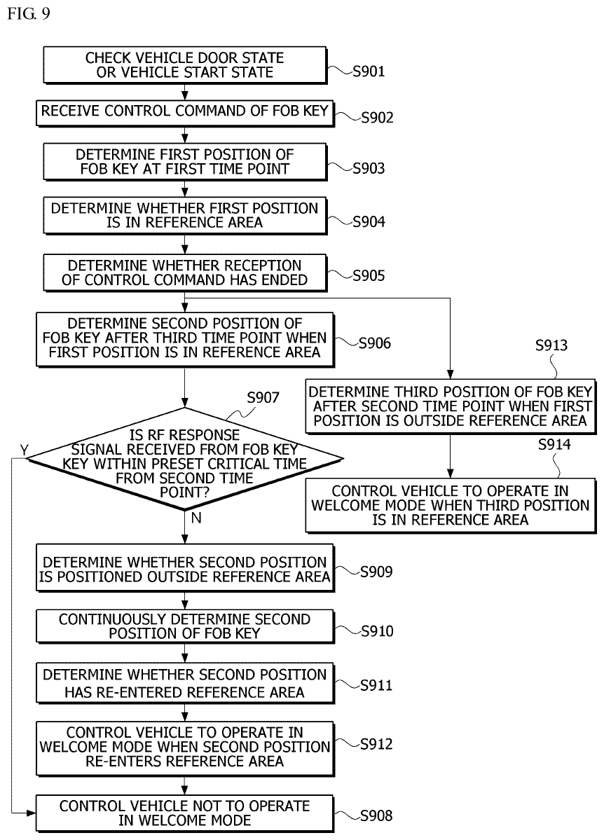

FIG. 9 is a flowchart of a method for controlling the vehicle according to another exemplary embodiment of the present disclosure.

First, a processor is configured to check a closed state of the vehicle door or a turned-off state of the vehicle (S901).

Next, a communication device of the vehicle receives a control command of a fob key (S902).

Next, the processor is configured to determine a first position of the fob key at a first time point when the control command of the fob key is first received (S903).

Next, the processor is configured to determine whether the first position is in a reference area (S904).

Next, the processor is configured to determine whether the reception of the control command has ended (S905).

In a case in which the first position of the fob key is in the reference area, the processor periodically determines a second position of the fob key from a third time point when a preset time elapses from the second time point when the reception of the control command ends (S906).

At the present time, the processor is configured to determine whether an RF response signal has been received from the fob key within a preset critical time from the second time point (S907).

When receiving the RF response signal from the fob key within the preset critical time from the second time point, the processor is configured to control the vehicle not to operate in a welcome mode (S908).

Next, the processor is configured to determine whether the second position of the fob key is positioned outside the reference area (S909).

The processor continuously determines the second position of the fob key when the second position of the fob key is positioned outside the reference area (S910).

Next, the processor is configured to determine whether the second position of the fob key has re-entered the reference area (S911).

When it is determined that the second position of the fob key has re-entered the reference area, the processor is configured to control the vehicle to operate in the welcome mode (S912).

Alternatively, in a case in which the first position of the fob key is outside the reference area, the processor periodically determines a third position of the fob key from the second time point when the reception of the control command ends (S913).

Next, when the third position is positioned in the reference area, the processor is configured to control the vehicle to operate in the welcome mode (S914).

The term “˜unit” used in an exemplary embodiment of the present disclosure means a software or hardware component such as a field-programmable gate array (FPGA) or an ASIC, and the “˜unit” performs certain roles. However, the “unit” is not limited to software or hardware. The “unit” may be configured to be disposed in an addressable storage medium and configured to reproduce one or more processors.

Therefore, as an exemplary embodiment of the present disclosure, the “unit” is components such as software components, object-oriented software components, class components, and task components, processes, functions, attributes, procedures, subroutines, segments of program code, drivers, firmware, microcode, circuits, data, database, data structures, tables, arrays, and variables. Functions provided in the components and “˜units” may be combined into the smaller number of components and “unit” or separated into additional components and “units.” Additionally, the components and “˜units” may be implemented to reproduce one or more CPUs in a device or a security multimedia card.

According to a vehicle and a method for controlling the same according to various exemplary embodiments of the present disclosure, it is possible to prevent the operation of a welcome function of a vehicle in an unintended situation.

Furthermore, it is possible to prevent discomfort caused by an unintended operation of the welcome function.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a specific operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle comprising:
at least one processor; and
a memory operatively connected to the at least one processor and configured to store one or more programs executed by the at least one processor,
wherein the at least one processor includes:
a first processing unit configured to determine a first position of a fob key at a first time of receiving a control command from the fob key, and to determine a position of the fob key within a preset time from an end of the reception of the control command; and
a second processing unit configured to restrict an operation of a welcome mode when both the first position of the fob key and the position of the fob key determined within the preset time are within a reference area relative to the vehicle.

2. The vehicle of claim 1, wherein the first processing unit determine the second position of the fob key after a third time point when a preset time elapses from a second time point when the reception of the control command ends when the first position is in a reference area; and
wherein the second processing unit configured to control the vehicle to operate in a welcome mode in response that the second position is in the reference area.

3. The vehicle of claim 2, wherein the first processing unit periodically determines the second position of the fob key using a radio frequency (RF) response signal received after the third time point.

4. The vehicle of claim 3, wherein the second processing unit controls the vehicle to operate in the welcome mode in response that the second position moves from an outside of the reference area to an inside of the reference area.

5. The vehicle of claim 2, wherein the first processing unit determines a third position of the fob key in response that the first position is outside the reference area.

6. The vehicle of claim 5, wherein the second processing unit controls the vehicle to operate in the welcome mode in response that the third position is in the reference area.

7. The vehicle of claim 2, wherein the first time point is a time point when the reception of the control command of the fob key starts in a locked state of doors of the vehicle.

8. The vehicle of claim 2, wherein the control command is continuously received for a predetermined time period.

9. The vehicle of claim 8, wherein the control command includes a window close command of the vehicle.

10. The vehicle of claim 2, wherein the second processing unit controls the vehicle not to operate in the welcome mode in response to receiving an RF response signal from the fob key within a preset time period from the second time point.

11. The vehicle of claim 2, wherein the vehicle provides at least one of automatic side mirror control, automatic door handle lighting control, automatic welcome light control, automatic indoor lighting control, automatic vehicle seat position control, automatic mirror position control, and automatic air conditioning function control functions in the welcome mode.

12. A method performed by a computing device including at least one processor and a memory operatively connected to the at least one processor and configured to store one or more programs executed by the at least one processor, the method comprising:
by the at least one processor,
determining a first position of a fob key at a first time of receiving a control command from the fob key,
determining a position of the fob key within a preset time from an end of the reception of the control command
restricting an operation of a welcome mode when both the position of the fob key determined at the time of receiving the control command and the position of the fob key determined within the preset time are within a reference area relative to the vehicle.

13. The method of claim 12, further comprising,
determining a second position of the fob key after a third time point when the preset time elapses from a second time point when the reception of the control command ends when the first position is in the reference area; and
controlling a vehicle to operate in a welcome mode when the second position is in the reference area.

14. The method of claim 13, wherein the determining of the second position of the fob key includes periodically determining the second position of the fob key using a radio frequency (RF) response signal after the third time point.

15. The method of claim 14, wherein the controlling of the vehicle to operate in the welcome mode includes:
determining whether the second position is outside the reference area;
determining whether the second position has entered from the outside of the reference area to an inside of the reference area; and
controlling the vehicle to operate in the welcome mode.

16. The method of claim 13, further including, after the determining of the first position, periodically determining a third position of the fob key from the second time point in response that the first position is outside the reference area.

17. The method of claim 16, wherein the controlling of the vehicle to operate in the welcome mode further includes controlling the vehicle to operate in the welcome mode in response that the third position is in the reference area.

18. The method of claim 13, wherein the first time point is a time point when the reception of the control command of the fob key starts in a locked state of doors of the vehicle.

19. The method of claim 13, further including controlling the vehicle not to operate in the welcome mode in response to receiving an RF response signal from the fob key within a preset time from the second time point.

20. The method of claim 13, wherein the controlling of the vehicle to operate in the welcome mode includes controlling the vehicle to provide at least one of automatic side mirror control, automatic door handle lighting control, automatic welcome light control, automatic indoor lighting control, automatic vehicle seat position control, automatic mirror position control, and automatic air conditioning function control functions.
